(19) United States
(12) Patent Application Publication
(10) Pub. No.: US 2011/0127298 A1
(43) Pub. Date: Jun. 2, 2011

(54) BOTTLE TOP DISPENSER WITH RECIRCULATING AND DRAINING MECHANISM

(76) Inventor: Chirag Narendrabhai Shah, Gandhinagar (IN)

(21) Appl. No.: 13/054,069

(22) PCT Filed: Aug. 24, 2009
(86) PCT No.: PCT/IN2009/000466

§ 371 Date: Jan. 13, 2011

(30) Foreign Application Priority Data
Apr. 22, 2009 (IN) 1069/MUM/2009

(51) Int. Cl. G01F 11/02; B65D 47/40; B05C 17/01

(52) U.S. Cl. 222/309; 222/424

(57) ABSTRACT

The present invention discloses a bottle top dispenser with dispensing, recirculation and draining mechanism, said dispenser operates in two modes one is dispensing mode and other is recirculation/draining mode, said bottle top dispenser comprising: calibration scale to measure the desired quantity of liquid to be dispensed; knob for selecting the desired quantity of liquid to be dispensed; piston cylinder arrangement for performing motion of liquid into or out of the bottle; spout being rotatable by 180° for selecting the operating mode of the bottle top dispenser; outer dispensing tube being connected to said spout for dispensing liquid out of the bottle through said spout; inner recirculating tube being used for recirculating liquid into bottle; threaded adaptor to allow dispenser to set firmly on the bottle; telescopic tube connecting bottle top dispenser and bottle for providing the path to the liquid into or out of the bottle; interconnecting region for establishing interconnection between piston cylinder arrangement and telescopic tube and between piston cylinder arrangement & threaded adaptor; and dual pair of notches being provided in interconnecting region such that in dispensing mode said outer dispensing tube establishes connection with interconnecting region through one of the pair of notches so that liquid can be dispensed out of the bottle and in recirculating mode said inner recirculating tube establishes connection with interconnecting region through other pair of notches so that liquid can be recirculation/drained in to the bottle.

### FIELD OF THE INVENTION

The present invention relates to device for dispensing a predetermined and accurate quanatity of liquid. More particularly it relates to a bottle top dispenser with dispensing, recirculation and draining mechanism. Most particularly it relates to a bottle top dispenser for accuratelty dispensing the predetermined amount of liquid from the bottle and performing both recirculation and draining of the liquid inside the bottle in a single action without any wastage of the liquid.

### BACKGROUND OF THE INVENTION

In various applications like pharmaceutical laboratories, clinical diagnostics and manufacturing industries, precise liquid samples are to be dispensed out from the bottles. Thus a bottle top type of liquid dispenser is essential where the volume of liquid to be dispensed out from the bottle is predetermined and thus exact volume of liquid is dispensed, maintaining the accuracy. The liquids used in these industries can be corrosive, harmful or explosive and generally costly thus unnecessary wastage of the liquid in the process of air purging from the liquid path can be hazardous as well as expensive. Thus a dispenser involving recirculation of the liquid inside the bottle is desired without any wastage of the liquid.

In conventional bottle top dispensers without recirculation, to dispense correct volume of liquid out of bottle, cylinder should be filled completely with liquid; air is to be removed from the liquid path. Thus the user may have to dispense out some liquid along with the air. After completion of work, some liquid may be left out in the spout as well as some time in the cylinder which has to be discarded or drained out. Thus in such type of liquid dispensers, liquid is wasted. Also bottle top dispensers with recirculation, does not drain back the liquid left in spout at the end of process. Whereas in the proposed invention of bottle top dispenser with recirculation and draining, initially the process of filling the cylinder completely with liquid can be achieved by recirculation the liquid back into the bottle and at the end of the process, liquid inside the cylinder and spout can be recirculated and drained back respectively in to the bottle. This system helps in preventing accidental and environmental hazards as well as it can save expensive liquid from being wasted.

### PRIOR ART

Various inventions related to liquid dispensers are known but they have several disadvantages as discussed below.

U.S. Pat. No. 3,940,027 discloses dispenser for a bottle top with a cylinder and a plunger that is adjustable relative to the cylinder for drawing up an adjustable quantity of liquid esp. reagent with a suction valve and a discharge valve and having a glass cylinder secured to a valve block which is threadedly received on a reagent bottle and where a cylinder sleeve slidably and rotably extends over the glass cylinder and is connected with the plunger which slides in the glass cylinder and where means are provided for adjusting the stroke of the plunger and to indicate the suction volume. The dispenser of this US patent can be used only for the purpose of dispensing the liquid and does not for fulfill the requirement of recirculation or draining the liquid.

The bottle top dispenser as described in U.S. Pat. No. 6,015,067 has valve housing and a piston-cylinder unit, adapted to be releasably affixed to the housing. The piston and cylinder can be activated in an axial stroke movement relative to one another, in order to draw liquid from a bottle on which the dispenser is set, and eject it. The intake process takes place in a spring-activated extension movement, and the ejection process takes place in a manually activated compression movement of the piston-cylinder unit. Apart from complex design and subsequent difficulty to manufacture, it does not facilitate recirculation and draining of the liquid inside the bottle.

U.S. Pat. No. 4,306,670 discloses a Liquid Dispensing Device proposing the use of flexible tube attached to the dispensing tip for the recirculation. It is disclosed in the specification that the end of the said flexible tube that may be inserted in the hole of the dispenser housing, thereby recirculating the liquid. However, the above said invention mainly stresses on usage of various resin made parts so as to provide long shelf life of the dispensing device over the prior glass usage. Moreover, the flexible tube itself presents a potential for an accidental leakage of liquid therefrom. Thus it must be handled with extreme care and caution else there are quite more chances of error some dispensing of liquid.

Another bottle top dispenser with a recirculation capability is disclosed in the European Patent Publication No. 542 241 A2. In that, the fill and dispense check valves are mounted in the dispenser body; and a recirculation valve is mounted in the dispensing spout or tip. Generally, the recirculation valve is rotatable between two positions, a first position permits liquid to be dispensed from the tip and, a second position causes the liquid to be recirculated through the spout, through the dispenser body and back into the bottle. In each of the several embodiments disclosed, the recirculation valve is designed to have separate dispense and recirculate paths there through depending on the valve position. The above design has several disadvantages. First, mounting the recirculation valve in the dispensing tip requires that dispenser tip be large and bulky. Such a design not only adds costs but may not be as pleasing in appearance as the more traditional sleeker, thinner dispenser tip designs. Second, by requiring separate dispense and recirculate paths through the recirculation valve substantially increases the complexity and cost of the recirculation valve.

U.S. Pat. No. 5,862,958 entitled “Bottle top dispenser” describes a dispenser, including a plunger and cylinder connected to a dispenser body, a flow control valve that rotates mounted in the dispenser body and has a valve fluid path connected between the cylinder and a control valve outlet. Advancing the plunger when the flow control valve is in a first—recirculation position pushes liquid from the cylinder, through a return path and back into the bottle. Advancing the plunger when the flow control valve is in a second—dispense position delivers liquid from the cylinder out through a dispensing orifice. Thus it requires a manually operable control valve that selectively provides either a dispensing mode or a recirculation mode for the liquid in the bottle. The extra control valve to change from the dispensing mode to recirculation mode makes the mechanism of the dispenser complex. Also it does not stop wastage of liquid left in spout after dispensing process in over.

Therefore, there continues to be a need to provide a bottle top dispenser devoid of the above limitations and which provides selectable dispensing, recirculation and draining capabilities that is compact, simple in design, easy to use, and less expensive to manufacture.

### OBJECTS OF THE INVENTION

The main object of this invention is to provide liquid dispensing device to obviate the above mentioned draw backs of the existing liquid dispensing device with recirculation.

Another object of this invention is to provide a bottle top liquid dispenser having both dispensing and recirculation mechanism.

Yet another object of this invention is to provide a bottle top dispenser capable of dispensing a predetermined volume of liquid from the bottle in which recirculation and drainage of the liquid occurs in a single action without wasting liquid.

Yet another object of this invention is to provide a bottle top dispenser which is simple in structure and has minimum space requirement.

Still another object of this invention is to provide a bottle top dispenser which is easy to operate.

### SUMMARY OF THE INVENTION

Accordingly to achieve the aforesaid objects present invention provides a bottle top dispenser with dispensing, recirculation and draining mechanism, said dispenser operates in two modes one is dispensing mode and other is recirculating and draining mode, said bottle top dispenser comprising:
Volume selecting mechanism for accurate measurement of the liquid to be dispensed;
liquid movement mechanism for performing motion of liquid into or out of the bottle;
mode selection mechanism for selecting the operating mode of the bottle top dispenser;
outer dispensing tube being connected to said mode selection mechanism for dispensing liquid out of the bottle through said liquid movement mechanism;
inner recirculating path being used for recirculation and draining liquid into bottle;
fitting mechanism for fitting said dispenser at the top of the bottle;
telescopic tube connecting dispenser with bottle for providing the path to the liquid into or out of the bottle;
interconnecting region for establishing interconnection between liquid movement mechanism and telescopic tube and between liquid movement mechanism & fitting mechanism; and
dual pair of notches being provided in interconnecting region such that in dispensing mode said outer dispensing tube establishes connection with interconnecting region through one of the pair of notches so that liquid can be dispensed out of the bottle and in recirculation and/or draining mode said inner recirculating path establishes connection with interconnecting region through other pair of notches so that liquid can be recalculated/drain in to the bottle.

According to one embodiment of the invention, the measuring unit is analog and it comprises calibration scale and knob for selecting the desired quantity of liquid to be dispensed.

According to another embodiment of the invention, the measuring unit is digital and it comprises knob for selecting the desired quantity of the liquid to be dispensed and digital display to indicate the selected quantity of liquid.

According to yet another embodiment of the invention the liquid movement mechanism comprises piston cylinder arrangement. The piston cylinder arrangement comprises piston being vertically movable inside the cylinder such that when piston is pulled up according to the desired quantity of the liquid to be dispensed, the liquid from the bottle is being aspirated into the cylinder and when piston is pushed down vertically the said aspirated liquid gets either dispensed out through outer dispensing tube or recalculated and/or drained back to bottle. The cylinder is made of glass material.

According to yet another embodiment of the invention the selection mechanism comprises an elongated spout. The said spout houses outer dispensing tube. The spout is connected to interconnecting region such that when said spout is rotated by 180° said dispenser changes from dispensing mode to recirculation and/or drain mode.

According to another embodiment of the invention the fitting mechanism comprises an adaptor having threads on its inner surface which locks with the threads provided on outer surface of the bottle.

According to another embodiment of the invention dispenser further comprises a drying tube being connected to interconnecting region for protecting the interconnecting region from moisture or atmospheric effect.

According to still another embodiment of the invention, a bottle top dispenser with dispensing recirculation and drain mechanism, said dispenser operates in two modes; one is dispensing mode and other is recirculation and/or drain mode, said bottle top dispenser comprising:
calibration scale to display the desired quantity of liquid to be dispensed;
knob for selecting the desired quantity of liquid to be dispensed;
piston cylinder arrangement for performing motion of liquid into or out of the bottle;
spout being rotatable by 180° for selecting the operating mode of the bottle top dispenser;
outer dispensing tube being connected to said spout for dispensing liquid out of the bottle through said spout;
inner recirculating path being used for recirculating liquid into bottle;
threaded adaptor to allow dispenser to set firmly on the bottle;
telescopic tube connecting bottle top dispenser and bottle for providing the path to the liquid into or out of the bottle;
interconnecting region for establishing interconnection between piston cylinder arrangement and telescopic tube and between piston cylinder arrangement & threaded adaptor; and
dual pair of notches being provided in interconnecting region such that in dispensing mode said outer dispensing tube establishes connection with interconnecting region through one of the pair of notches so that liquid can be dispensed out of the bottle and in recirculation and draining mode said inner recirculating path establishes connection with interconnecting region through other pair of notches so that liquid can be recirculated and/or drained in to the bottle.

### BRIEF DESCRIPTION OF THE DRAWINGS

FIG. 1: Shows the perspective view of the bottle top dispenser with dispensing, recirculation and draining mechanism in accordance with the present invention particularly when it is in dispensing mode.

FIG. 2: Shows the detailed view of the bottle top dispenser with dispensing, recirculation and draining mechanism in accordance with the present invention particularly when it is in dispensing mode.

FIG. 3: Shows the dispensing mode of the bottle top dispenser of the present invention especially showing the position of notches in dispensing mode.

FIG. 4: Shows the perspective view of the bottle top dispenser with dispensing, recirculation and draining mechanism in accordance with the present invention particularly when it is in recirculation and/or draining mode.

FIG. 5: Shows the detailed view of the bottle top dispenser with dispensing, recirculation and draining mechanism in accordance with the present invention particularly when it is in recirculation and/or draining mode.

FIG. 6: Shows the dispensing mode of the bottle top dispenser of the present invention especially showing the position of notches in recirculating/draining mode.

FIG. 7: Shows the left side view of the bottle top dispenser with dispensing, recirculation and draining mechanism in accordance with the present invention particularly when it is in dispensing mode.

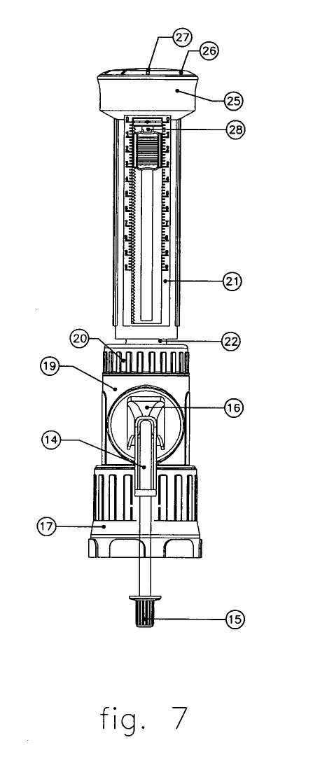

FIG. 8: Shows the right side view of the bottle top dispenser with dispensing recirculation and draining mechanism in accordance with the present invention particularly when it is in dispensing mode.

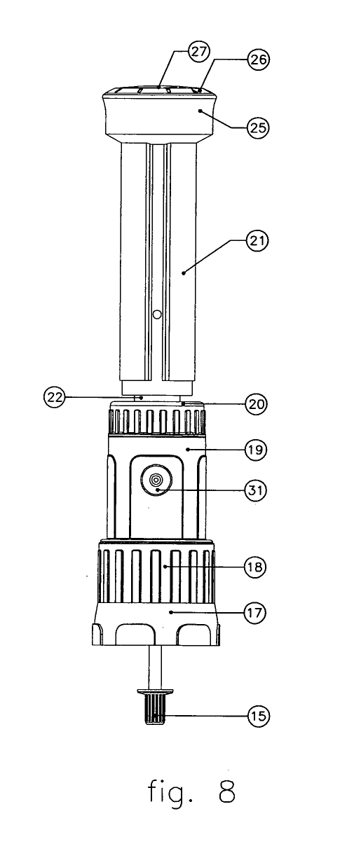

FIG. 9: Shows the front view of the bottle top dispenser with dispensing recirculation and draining mechanism in accordance with the present invention particularly when it is in dispensing mode.

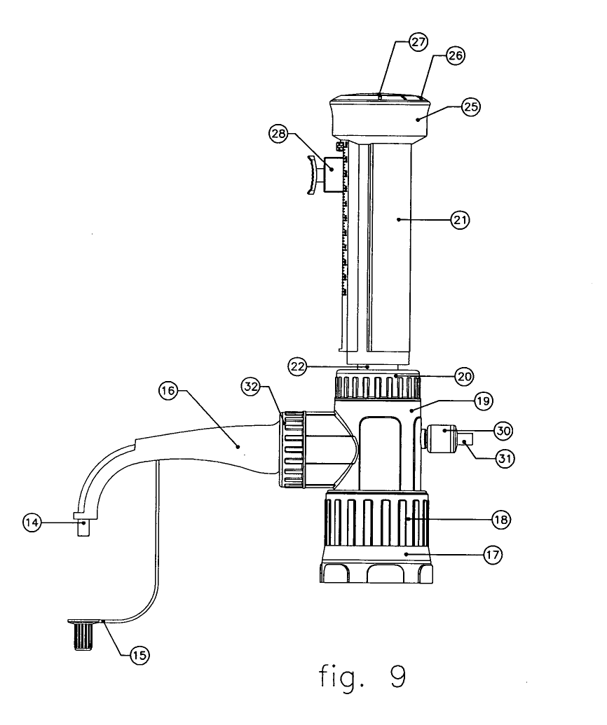

FIG. 10: Shows the top view of the bottle top dispenser with dispensing recirculation and draining mechanism in accordance with the present invention particularly when it is in dispensing mode.

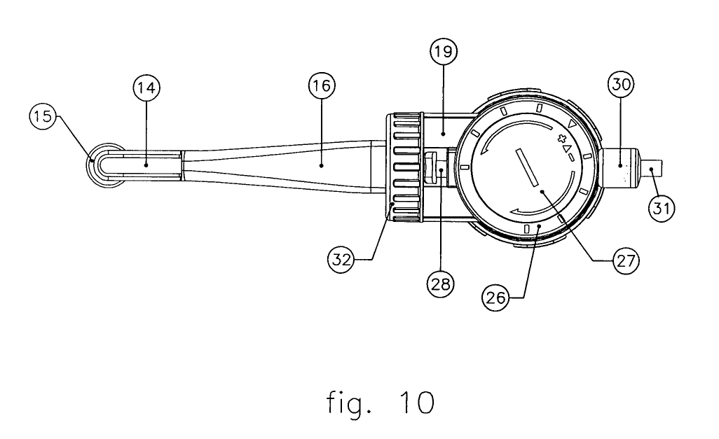

FIG. 11: Shows the bottom view of the bottle top dispenser with dispensing recirculation and draining mechanism in accordance with the present invention particularly when it is in dispensing mode.

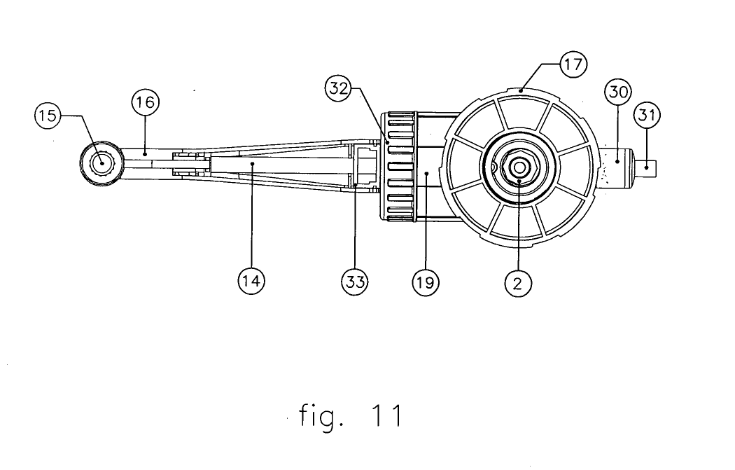

### DETAILED DESCRIPTION OF THE INVENTION

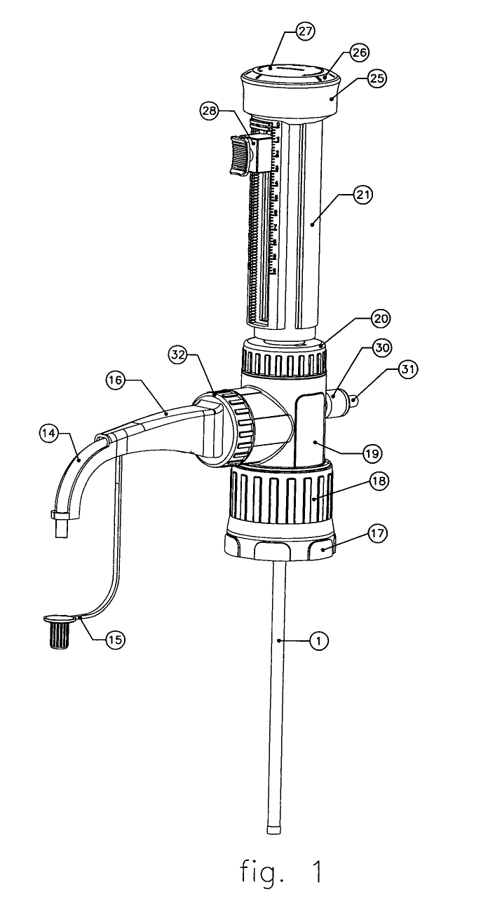

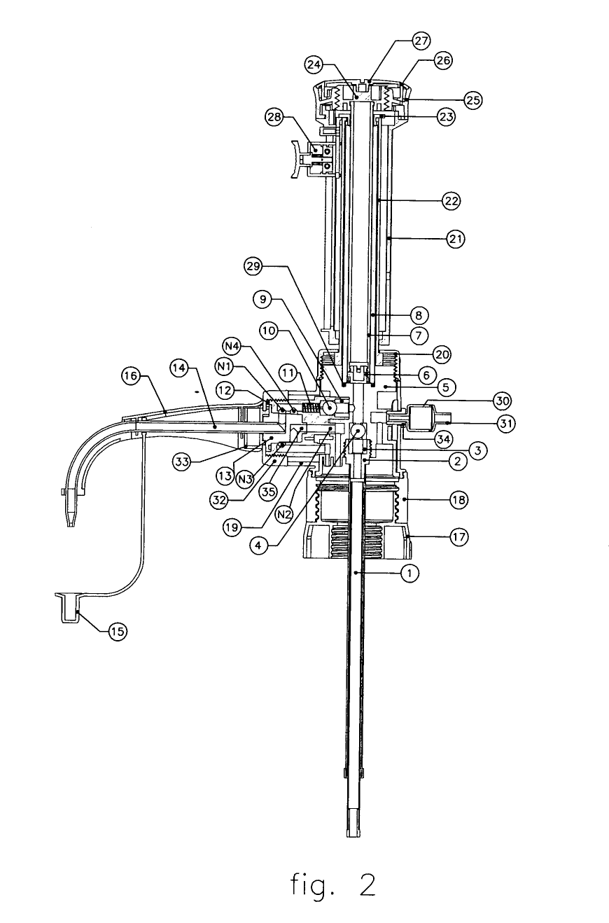

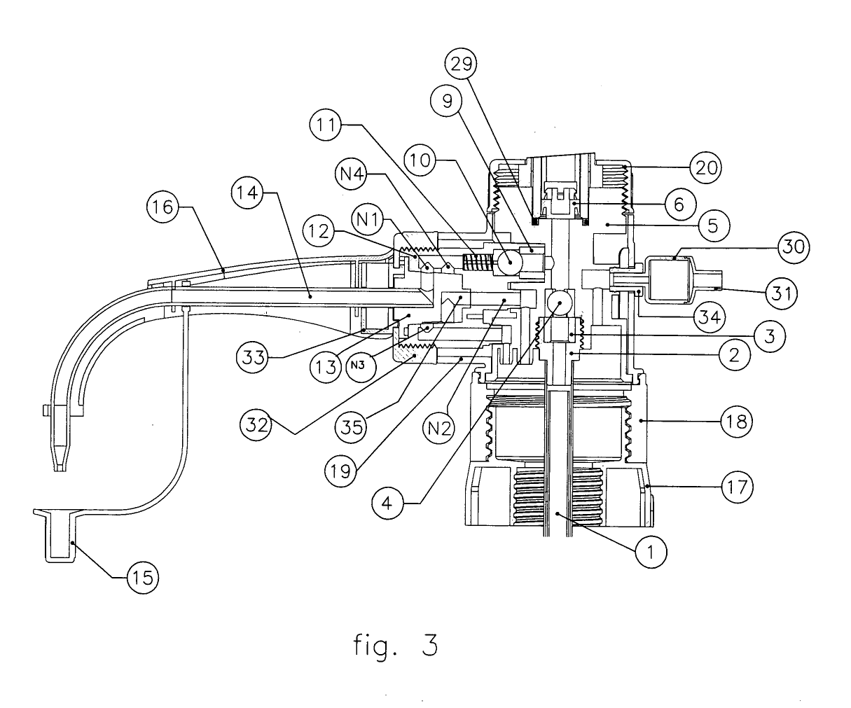

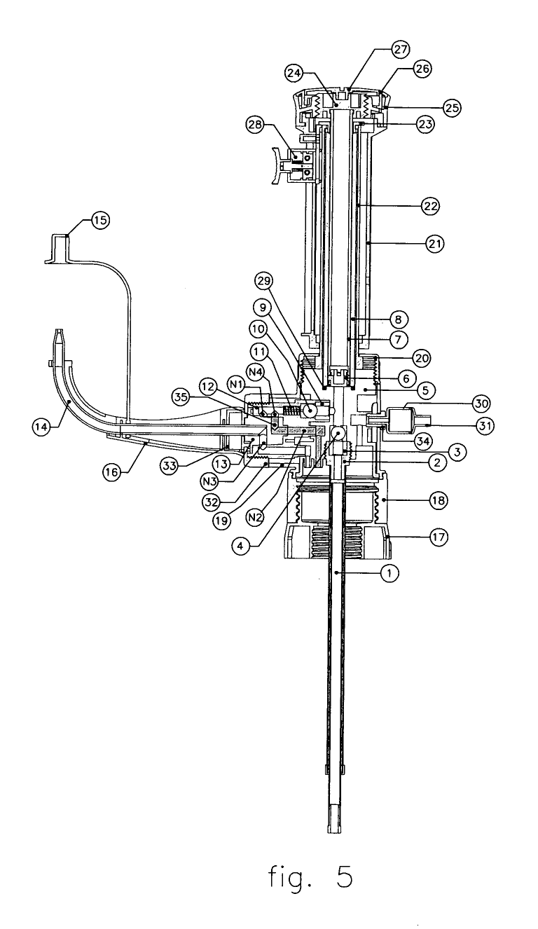

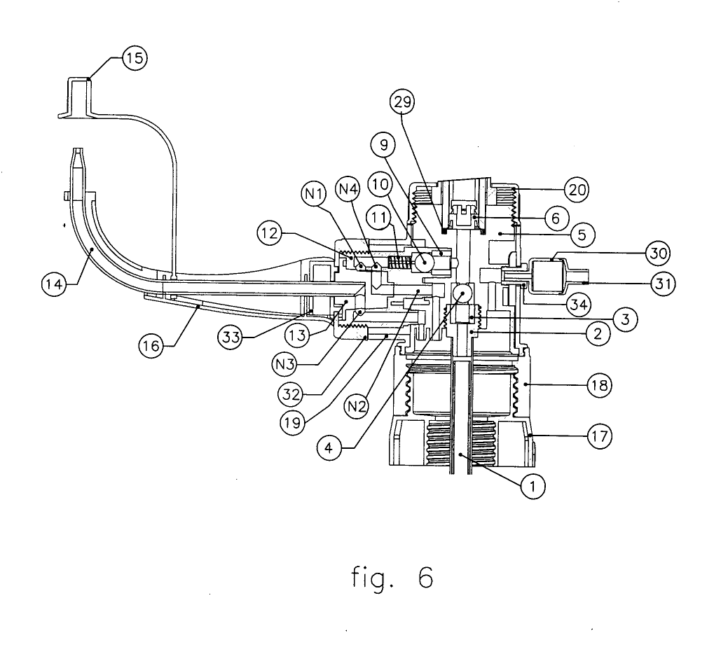

Referring to FIGS. 1-6, the bottle top dispenser in accordance to present invention consists of three parts mainly upper, middle and lower part. The upper part takes care of accurate selection of quantity of liquid to be dispensed. The middle part takes care of accurate and proper dispensing, recirculation and draining of the liquid. The lower part takes care of proper fitting of the dispenser to the bottle from which liquid is to be dispensed out or recalculated/drained in.

The upper part mainly consists of piston cylinder mechanism (7, 8) and measuring mechanism (26, 27). The piston cylinder mechanism (7, 8) and measuring mechanism (26, 27) are placed in the housing (21). The housing (21) is covered at the top by a cap (25).

The piston-cylinder mechanism (7, 8) contains piston (7) with head (24) at the top and glass cylinder (8). The piston (7) moves vertically inside the glass cylinder (8). The cylinder (8) has a covering (22) over it which can be locked by locking means (23). The measuring mechanism (26, 27) is used to select the desired volume of liquid to be dispensed. The measuring mechanism (26, 27) contains calibration scale (26) and calibration knob (27) by which desired volume of the liquid can be selected. The knob (27) is mechanically connected to calibration scale (26). Instead of using calibration scale one can use digital display system to indicate the selected volume of liquid. There is a lock assembly (28) provided with measuring mechanism (26, 27) for ensuring to take exact volume of the liquid which is set by the user.

The middle part mainly consists of spout (16), outer dispensing tube (14), inner recirculation path (35), spring (11) and a path (5) for connecting upper and bottom parts of the bottom top dispenser.

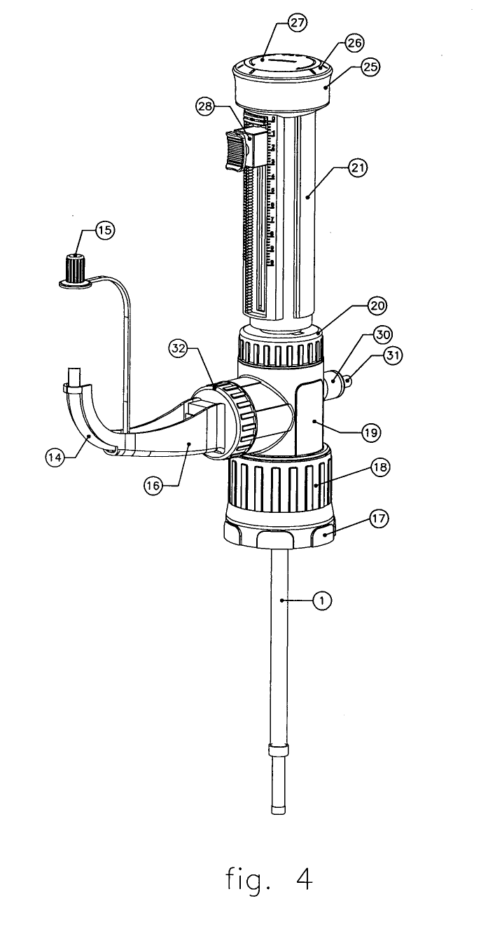

The spout (16) houses the outer dispensing tube (14) to dispense desired liquid out. The position of spout decides the mode of the bottle top dispenser. In one position the bottle top dispenser works in dispenser mode. Such position is shown in FIGS. 1 to 3. In other position the bottle dispenser works in recirculation and/or drain mode. Such position is shown in FIGS. 4 to 6. The spout is attached in such a way that it can be rotated by 180° and thus convert the dispenser from dispense mode to recirculation and/or drain mode. A cap outlet lock (15) is provided at the tip of the spout so that no liquid can drip out from the spout (16). The spout (16) and outer dispensing tube (14) are connected to path (5) by means of tubular outlet housing (12). The said housing (12) consists of outlet region (13). At the outlet region (13), notches n1, n2, n3, n4 where the outer dispensing tube (14) and inner recirculation path (35) attaches themselves with the notches and helps in changing from dispensing mode to the recirculation and/or drain mode and vice-versa. The aspiration, dispensing, recirculation and drainage mechanism of the liquid occurs in this part of the bottle top dispenser.

A cap (32) is provided at the point of connection between spout (16) and the outlet housing (12). The path (5) plays very vital role in working of the bottle top dispenser. It is made of Polytetrafluoroethylene (PTFE). At the time of aspiration, liquid pass to cylinder cover (22) from lower part through path (5). At the time of dispensing liquid pass in cylinder cover (22) to outlet housing (12) through path (5). A cap (20) is provided at the top of the path (5) for connecting path (5) to housing (21). The path (5) has cover (19).

A drying tube (30) is also provided in the middle part to protect the path (5) form moisture or atmospheric effect. One hole is provided inside the tube (30) to fill powder to protect from moisture or atmospheric effect and prevent foreign particle inside the path (5). The tube (30) is also provided with cap (31) to close tube (30) after filling of the powder inside drying tube is completed. Further air lock nut (34) is provided in the middle part which is directly fit with the path (5). One hole in centre of air lock nut (34) is provided for drying tube (30) fitment. It is a member between path (5) and drying tube (30). When another bottle needs to fit with bottle top dispenser, one can remove drying tube assembly and connect another bottle directly to the air lock nut (34) through an elongated tube.

The lower part mainly consists of an adaptor (17) and telescopic tube (1). An adaptor (17) allow dispenser to set firmly on bottle. The adaptor (17) has threads on its inner surface which locks with outside threads of bottle when the adaptor (17) is rotated in clockwise direction. The telescopic tube (1) permits drawing of liquid from the bottle for dispensing as well as recirculation. The height of the tube (1) is depending upon size of bottle and amount of liquid inside. A Tube fitting nut (2) is provided to ensure proper fitting of the tube (1).

Working of the Bottle Top Dispenser in Accordance to the Present Invention:

The bottle top dispenser with dispensing recirculation and draining mechanism serves two main purposes, one is dispensing accurate amount of liquid from the bottle and second is recirculation and draining the liquid inside the bottle. The present invention is designed in such a manner that by rotating the spout (16) 180° from its normal position the dispenser can be converted from dispense mode to recirculation and/or drain mode.

Referring to FIGS. 1 to 3, in the dispense mode i.e. when the spout (16) is in its normal position the outer dispensing tube (14) is attached to notch n1 and the inner path (35) is attached to notch n4. When the piston (7) is pulled up till its maximum possible position according to the desired volume to be dispensed, the liquid from the bottle is being aspirated in to the cylinder (8). When piston (7) is pushed down vertically from its top most possible position, the liquid that is aspirated inside cylinder (8) gets dispensed out from the spout (16). Thus the dispensing of the liquid from the bottle occurs.

Referring to FIGS. 4 to 6, in the recirculation and/or draining mode i.e. when the spout (16) is rotated by 180° the outer dispensing tube (14) is attached to notch n3 and the inner path (35) is attached to notch n2. Since outer dispensing tube is connected to notch n3 the liquid is stopped from dispensing out of the bottle while connection of inner path (35) to notch n2 permits the liquid back into the bottle. When the piston (7) is compressed in this position, the liquid that was aspirated from the bottle enters the telescopic tube (1). Thus the liquid entering the telescopic tube (1) goes back into the bottle through the inner path (35) and telescopic tube (1) after recirculation. Moreover in this mode the outer dispensing tube (14) attaches at notch n3 and thus the liquid remaining inside the spout (16) is also driven back into the bottle. Thus here recirculation and drainage of the liquid is carried out simultaneously without any wastage of the liquid.

In the proposed invention of bottle top dispenser with recirculation and/or draining, the liquid goes back into the bottle after recirculation and even the liquid inside the spout is drained back into the bottle. Thus unnecessary wastage of the liquid is spared. Thus this bottle top dispenser with recirculation and/or draining helps in dispensing predetermined amount of liquid from the bottle without any wastage of the liquid in the process of recirculation and drainage.

List of the reference numerals used in the drawings:

| Reference Numeral | Description |
|---|---|
| 1 | Telescopic tube |
| 2 | Tube fitting nut |
| 3 | Glass Seat |
| 4 | Glass ball |
| 5 | Path |
| 6 | Piston seal |
| 7 | Piston |
| 8 | Glass cylinder |
| 9 | Glass Seat |
| 10 | Glass ball |
| 11 | Spring |
| 12 | Outlet Housing |
| 13 | Outlet Region |
| 14 | Outer dispensing Tube |
| 15 | Cap Outlet Lock |
| 16 | Spout |
| 17 | Threaded adaptor |
| 18 | Bottle Thread Nut |
| 19 | Path Cover |
| 20 | Cap |
| 21 | Housing |
| 22 | Cylinder Cover |
| 23 | Cylinder Cover Lock |
| 24 | Piston Head |
| 25 | Cap |
| 26 | Calibration Scale |
| 27 | Calibration Knob |
| 28 | Lock assembly |
| 29 | Polytetrafluoroethylene (PTFE) |
| | Seal & ‘O’ Ring |
| 30 | Drying Tube |
| 31 | Drying Tube Cap |
| 32 | Outlet Housing Cap |
| 33 | Spout Base |
| 34 | Air Lock Nut |
| 35 | Inner path |
| n1, n2, n3, n4 | Notches |

### Advantages of the Bottle Top Dispenser of The Present Invention:

i. It is formed of common and easily available materials and hence inexpensive to produce.
ii. It is easy to use.
iii. Its mechanism helps in preventing accidental and environmental hazards and avoids the expensive liquid from being wasted.
iv. It can drain back the liquid left in spout once dispensing process is over.
v. It is compact in construction and hence having aesthetic appearance.

The present invention is not limited to the above-described embodiments, and various alterations, modifications, and/or alternative applications of the invention may be possible, if desired, without departing from the scope and spirit of the invention, which can be read from the claims and the entire specification. All these possible alterations, modifications, and/or alternative applications of the invention are also intended to be within technical scope of the present invention.

1.-22. (canceled)

23. A bottle top dispenser with dispensing, recirculation and draining mechanism, said dispenser operates in two modes where one is dispensing mode, the other is recirculation and/or draining mode, said bottle top dispenser comprising:
a measuring mechanism for accurate selection of the liquid to be dispensed;
a liquid movement mechanism for performing motion of liquid into or out of the bottle;
a mode selection mechanism for selecting the operating mode of the bottle top dispenser;
an outer dispensing tube being connected to said mode selection mechanism for dispensing liquid out of the bottle through said liquid movement mechanism;
an inner recirculating path being used for recirculating liquid into bottle;
a fitting mechanism for fitting said dispenser at the top of the bottle;
a telescopic tube connecting dispenser and bottle for providing the path to the liquid into or out of the bottle;
an interconnecting region for establishing interconnection between liquid movement mechanism and telescopic tube and between liquid movement mechanism & fitting mechanism;
wherein the mode selection mechanism comprises an elongated spout, the spout is connected to Interconnecting region such that when said spout is rotated by 180° said dispenser changes from dispensing mode to recirculation and/or draining mode and in that dual pair of notches being provided in interconnecting region for implementing the selected operating mode of the bottle top dispenser in association with the spout such that in dispensing mode said outer dispensing tube establishes connection with interconnecting region through one of the pair of notches so that liquid can be dispensed out of the bottle and in recirculation and/or draining mode said inner recirculating path establishes connection with interconnecting region through other pair of notches so that liquid can be recalculated and/or drained in to the bottle.

24. The bottle top dispenser as claimed in claim 23 wherein the measuring unit is analog.

25. The bottle top dispenser as claimed in claim 24 wherein the measuring unit comprises a calibration scale to measure the desired quantity of liquid to be dispensed and a knob for selecting the desired quantity of liquid.

26. The bottle top dispenser as claimed in claim 23 wherein the measuring unit is digital.

27. The bottle top dispenser as claimed in claim 26 wherein the measuring unit comprises a knob for selecting the desired quantity of the liquid to be dispensed and digital display to indicate the desired quantity of liquid.

28. The bottle top dispenser as claimed in claim 23 wherein the liquid movement mechanism comprises a piston cylinder arrangement.

29. The bottle top dispenser as claimed in claim 28 wherein the piston cylinder arrangement comprises a piston being vertically movable inside the cylinder such that when the piston is pulled up according to the desired quality of the liquid to be dispensed the liquid from the bottle is aspirated into the cylinder and when the piston is pushed down vertically the aspirated liquid gets dispensed out through outer dispensing tube or delivered back into the bottle when the bottle top dispenser is in recirculation and drain mode.

30. The bottle top dispenser as claimed in claim 29 wherein the cylinder is made of a glass material.

31. The bottle top dispenser as claimed in claim 23 wherein said spout houses an outer dispensing tube.

32. The bottle top dispenser as claimed in claim 23 wherein the fitting mechanism comprises an adaptor having threads on its inner surface which locks with the threads provided on an outer surface of the bottle.

33. The bottle top dispenser as claimed in claim 23 wherein the interconnecting region is made of polytetrafluoroethylene (PTFF).

34. The bottle top dispenser as claimed in claim 23 further comprising a drying tube being connected to the interconnecting region for protecting the interconnecting region from moisture or atmospheric effect.

35. A bottle top dispenser with a dispensing recirculation and draining mechanism, said dispenser operates in two modes; one is a dispensing mode and other is a recirculation and/or draining mode, said bottle top dispenser comprising:
a calibration scale to display the desired quantity of liquid to be dispensed;
a knob for selecting the desired quantity of liquid to be dispensed;
a piston cylinder arrangement for performing motion of liquid into or out of the bottle;
an outer dispensing tube being connected to said spout for dispensing liquid out of the bottle through said spout;
an inner recirculating path being used for recirculating liquid into bottle;
a threaded adaptor to allow dispenser to set firmly on the bottle;
a telescopic tube connecting bottle top dispenser and bottle for providing the path to the liquid into or out of the bottle;
an interconnecting region for establishing interconnection between piston cylinder arrangement and telescopic tube and between piston cylinder arrangement and threaded adaptor;
the spout being rotatable by 180° for selecting the operating mode of the bottle top dispenser, the spout being connected to an interconnecting region such that when said spout is rotated by 180° said dispenser changes from dispensing mode to recirculation and/or draining mode, and two pair of notches being provided in the interconnecting region for implementing the selected operating mode of the bottle top dispenser in association with the spout such that in dispensing mode said outer dispensing tube establishes a connection with the interconnecting region through one of the pair of notches so that liquid can be dispensed out of the bottle and in recirculation and/or draining mode said inner recirculating path establishes a connection with the interconnecting region through the other pair of notches so that liquid can be recalculated and/or drained into the bottle.

36. The bottle top dispenser as claimed in claim 37 wherein the piston cylinder arrangement comprises a piston being vertically movable inside the cylinder such that when the piston is pulled up according to the desired quality of the liquid to be dispensed the liquid from the bottle is aspirated into the cylinder and when the piston is pushed down vertically the aspirated liquid gets dispensed out through the outer dispensing tube.

37. The bottle top dispenser as claimed in claim 35 wherein the cylinder is made of a glass material.

38. The bottle top dispenser as claimed in claim 35 wherein said spout houses an outer dispensing tube.

39. The bottle top dispenser as claimed in claim 35 wherein the interconnecting region is made of polytetrafluoroethylene (PTFE).

40. The bottle top dispenser as claimed in claim 35 further comprising a drying tube being connected to the interconnecting region for protecting the interconnecting region from moisture or an atmospheric effect.
